(19) United States
(12) Patent Application Publication
(10) Pub. No.: US 2013/0333390 A1
(43) Pub. Date: Dec. 19, 2013

(54) Cooling air inlet, engine bleed air system and method for operating a cooling air inlet

(71) Applicant: Airbus Operations GmbH, Hamburg (DE)

(72) Inventors: Jan Barkowsky, Hamburg (DE); Jan Dittmar, Hamburg (DE); Juergen Kelnhofer, Hamburg (DE)

(21) Appl. No.: 13/971,188

(22) Filed: Aug. 20, 2013

Related U.S. Application Data
(63) Continuation of application No. PCT/EP2012/000758, filed on Feb. 21, 2012.
(60) Provisional application No. 61/444,826, filed on Feb. 21, 2011.

(30) Foreign Application Priority Data
Feb. 21, 2011 (DE) 10 2011 011 879.9

(51) Int. Cl. F02C 7/00

(52) U.S. Cl. CPC F02C 7/00
USPC 60/782; 60/785

(57) ABSTRACT

A cooling air inlet which is particularly suitable for use in an engine bleed air system of an aircraft air conditioning system. The cooling air inlet comprises a cooling air inlet opening which opens into an inlet portion of a cooling air line. A cooling air inlet valve which is positionable in a first open position or a second open position is arranged in the inlet portion of the cooling air line. The cooling air inlet valve is adapted to effect the build-up of a first cooling air admission pressure in the inlet portion of the cooling air line in its first open position and the build-up of a second cooling air admission pressure in the inlet portion of the cooling air line in its second open position. The second cooling air admission pressure is greater than the first cooling air inlet pressure.

### CROSS-REFERENCES TO RELATED APPLICATIONS

This application is a continuation of International Application PCT/EP2012/000758 filed Feb. 21, 2012, designating the United States and published on Aug. 30, 2012 as WO 2012/113541. This application also claims the benefit of the U.S. Provisional Application No. 61/444,826, filed on Feb. 21, 2011, and of the German patent application No. 10 2011 011 879.9 filed on Feb. 21, 2011, the entire disclosures of which are incorporated herein by way of reference.

### BACKGROUND OF THE INVENTION

The present invention relates to a cooling air inlet which is particularly suitable for use in an engine bleed air system of an aircraft air conditioning system. The invention furthermore relates to an engine bleed air system equipped with a cooling air inlet of this type and a method for operating a cooling air inlet of this type.

In commercial aircraft, so-called air-supported air conditioning systems are currently conventionally used for air conditioning the aircraft cabin. An aircraft air conditioning system serves for cooling the aircraft cabin, which would otherwise become too hot due to thermal loads such as, for example, solar radiation, body heat from the passengers and waste heat from devices present on board the aircraft. Moreover, the aircraft air conditioning system supplies sufficient fresh air into the aircraft cabin to ensure that a required minimum oxygen content is present in the aircraft cabin. Air-supported aircraft air conditioning systems generally comprise an air conditioning unit to which compressed process air is supplied by the engines of the aircraft.

FIG. 1 shows an engine bleed air system 10 described for example in DE 10 2010 054 448, which serves to extract hot bleed air from an aircraft engine 12 for the purpose of supplying process air to an air conditioning unit 13 of the aircraft air conditioning system. The engine bleed air system 10 comprises an engine bleed air line 14 which has, at its first end, a first and a second engine bleed air line branch 14a, 14b. The engine bleed air line branches 14a, 14b are connected at different positions to a high pressure compressor 16 of the engine 12. Hot engine bleed air extracted from the engine 12 in the region of the high pressure compressor 16 therefore flows into the engine bleed air line 14 via the engine bleed air line branches 14a, 14b.

The engine bleed air flowing through the engine bleed air line branch 14b has a higher system pressure than the engine bleed air which is discharged from the high pressure compressor 16 of the engine 12 of the aircraft through the engine bleed air line branch 14a. To prevent the more highly pressurized engine bleed air from the engine bleed air line branch 14b flowing back into the engine 12 by way of the engine bleed air line branch 14a, a non-return valve 18 is arranged in the engine bleed air line branch 14a. The flow of engine bleed air through the engine bleed air line branch 14b is controlled by a first control valve 20. A second control valve 22 controls the flow of bleed air through the engine bleed air line 14 downstream of the engine bleed air line branches 14a, 14b.

Extracting the bleed air in the region of the high pressure compressor 16 of the engine 12 ensures that the bleed air flowing through the engine bleed air line 14 is supplied to the air conditioning unit 13 of the aircraft air conditioning system at a sufficiently high pressure. However, depending on the operating state of the engine 12, the bleed air flowing out of the high pressure compressor 16 of the engine 12 into the engine bleed air line 14 is possibly at a temperature which exceeds a maximum permissible temperature for further distribution of the bleed air in the aircraft. In order to protect aircraft components from hot bleed air in the event of a bleed air leak in the vicinity of the engine bleed air line 14, and to prevent any flammable fuel/air mixtures which may develop in the region of the engine 12 from igniting, it is therefore necessary to reduce the temperature of the bleed air flowing through the engine bleed air line 14 still within the engine perimeter. For this reason, the engine bleed air system 10 comprises a preheat exchanger 24 which is conventionally integrated in the region of the engine suspension and serves to cool the engine bleed air flowing through the engine bleed air line 14.

Cooling air, so-called fan air, which is extracted from the engine 12 in the region of an engine fan 26 and supplied to the preheat exchanger 24 by way of a cooling air line 28, serves to cool the engine bleed air flowing through the preheat exchanger 24. After flowing through the preheat exchanger 24, the cooling air is discharged into the environment. The cooling air flow through the cooling air line 28 and the preheat exchanger 24 is controlled by means of a throttle valve 30. The cooling air is conventionally conveyed through the cooling air line 28 such that it is driven exclusively by differential pressure, i.e., without the use of additional active conveying elements. In order to ensure an adequate cooling air flow through the cooling air line 28, it is therefore necessary for the cooling air admission pressure prevailing in the region of a cooling air inlet 32 of the cooling air line 28 to be greater than the sum of all pressure losses occurring during the passage through the cooling air line 28.

To ensure that the cooling air admission pressure prevailing in the region of the cooling air inlet 32 of the cooling air line 28 is also adequate for operating states of the engine bleed air system 10 with a high cooling air requirement and in the event of faults, the cooling air inlet 32 is conventionally designed so that it enables a high pressure recovery with respect to the fan air pressure prevailing in the region of the engine fan 26 in all operating states of the engine bleed air system 10. For example, the cooling air inlet 32 can have an airscoop projecting into a fan air boundary layer. However, a cooling air inlet 32 which is designed in this way necessarily causes a high parasitic resistance in the fan air flow. This results in a reduction in the thrust performance of the engine 12 and an increase in the fuel consumption of the engine 12.

### SUMMARY OF THE INVENTION

The object of the invention is to provide a cooling air inlet which enables efficient operation of an engine bleed air system, equipped with the cooling air inlet, of an aircraft air conditioning system. The invention is furthermore based on the object of providing an engine bleed air system which is equipped with a cooling air inlet of this type and a method for operating a cooling air inlet of this type.

The object is achieved by a cooling air inlet having the features of Claim 1, an engine bleed air system having the features of Claim 9 and a method for operating a cooling air inlet having the features of Claim 10.

A cooling air inlet according to the invention, which is particularly suitable for use in an engine bleed air system of an aircraft air conditioning system, comprises a cooling air inlet opening which opens into an inlet portion of a cooling air line. The cooling air line can serve for example to supply cooling air to a preheat exchanger for cooling hot engine bleed air extracted from a high pressure compressor of an aircraft engine. Fan air extracted for example from the aircraft engine in the region of an engine fan can be supplied to the cooling air line by way of the cooling air inlet opening The cooling air inlet opening is preferably constructed in a surface element, for example a flow deflector plate or a portion of a housing arranged in the region of an engine suspension, over the surface of which cooling air to be supplied to the cooling air line by way of the cooling air inlet opening flows during operation of the cooling air inlet.

The cooling air inlet according to the invention further comprises a cooling air inlet valve which is arranged in the inlet portion of the cooling air line and may be positioned in a first open position or a second open position in the inlet portion of the cooling air line. Both in its first open position and in its second open position, the cooling air inlet valve enables the supply of cooling air through the cooling air inlet opening into the cooling air line. However, the cooling air inlet valve is adapted to effect the build-up of a first cooling air admission pressure in the inlet portion of the cooling air line in its first open position and to effect the build-up of a second cooling air admission pressure in the inlet portion of the cooling air line in its second open position. The second cooling air admission pressure is greater than the first cooling air admission pressure.

In other words, in the cooling air inlet according to the invention, positioning the cooling air inlet valve accordingly in its first open position or its second open position enables the cooling air admission pressure building up in the inlet portion of the cooling air line during operation of the cooling air inlet to be adjusted as desired. In those operating states of an engine bleed air system equipped with the cooling air inlet according to the invention in which there is a low cooling air requirement, reducing the cooling air admission pressure building up in the inlet portion of the cooling air line accordingly enables the parasitic resistance in the fan air flow caused by the cooling air inlet to be minimized. It is thus possible to minimize the negative influences on the thrust performance and the fuel consumption of the engine which are caused by the cooling air inlet. In operating states of the engine bleed air system in which there is a high cooling air requirement, on the other hand, the cooling air inlet ensures that sufficient cooling air is supplied to the cooling air line by realizing a high cooling air admission pressure in the inlet portion of the cooling air line. Adapting the cooling air admission pressure building up in the inlet portion of the cooling line to the cooling air requirement of an engine bleed air system equipped with the cooling air inlet according to the invention therefore enables efficient operation of the engine bleed air system overall.

In a preferred embodiment of the cooling air inlet according to the invention, the position of the cooling air inlet valve in the inlet portion of the cooling air line is incrementally or continuously variable between the first and the second open position of the cooling air inlet valve. The cooling air inlet valve can furthermore be adapted that, in an intermediate position between its first and its second open position, it effects the build-up of an intermediate cooling air admission pressure in the inlet portion of the cooling air line which is greater than the first cooling air admission pressure and less than the second cooling air admission pressure. In such a design of the cooling air inlet valve, the cooling air volume flow through the cooling air line can be adjusted incrementally or continuously depending on the cooling air requirement of the engine bleed air system equipped with the cooling air inlet according to the invention.

The cooling air inlet valve of the cooling air inlet according to the invention can be adapted to free a first through-flowable cross-section of the inlet portion of the cooling air line in its first open position and to free a second through-flowable cross-section of the inlet portion of the cooling air line in its second open position. The second through-flowable cross-section of the inlet portion of the cooling air line can be greater than the first through-flowable cross-section of the inlet portion of the cooling air line. If the cooling air inlet valve in its second open position not only effects the build-up of an increased cooling air admission pressure in the inlet portion of the cooling air line, but also frees a greater through-flowable cross-section of the inlet portion of the cooling line, a greater cooling air volume flow can be conveyed through the cooling air inlet opening into the cooling air line. Therefore, even in the event of faults or in operating states of an engine bleed air system equipped with the cooling air inlet which have a very high cooling air requirement, the cooling air inlet according to the invention ensures that the cooling air line has an adequately high cooling air volume flow flowing through it.

The cooling air inlet valve is preferably accommodated completely in the inlet portion of the cooling air line in its first open position. In its first open position, the cooling air inlet valve then causes a particularly low parasitic resistance in the fan air flow and consequently impairs the thrust performance and the fuel consumption of the engine only slightly.

Conversely, a portion of the cooling air inlet valve can be arranged outside the inlet portion of the cooling air line and project into an air flow flowing over the cooling air inlet opening when the cooling air inlet valve is positioned in its second open position. A portion of the cooling air inlet valve projecting into an air flow flowing over the cooling air inlet opening enables the cooling air admission pressure in the inlet portion of the cooling air line to be increased in particularly effective manner.

The portion of the cooling air inlet valve which is arranged outside the inlet portion of the cooling line and projects into an air flow flowing over the cooling air inlet opening can be constructed for example in the form of an airscoop. An inventive cooling air inlet with a cooling air inlet valve which is located in its second open position is then temporarily constructed in the form of a scoop air inlet which enables a high pressure recovery with respect to the fan air pressure prevailing in the region of an engine fan and can consequently realize the generation of a high cooling air admission pressure in the inlet portion of the cooling air line.

In a preferred embodiment of the cooling air inlet according to the invention, the cooling air inlet valve in the inlet portion of the cooling air line may furthermore be positioned in a closed position in which the cooling air inlet valve closes the inlet portion of the cooling air line. If the cooling air inlet valve is in its closed position, the supply of cooling air to the cooling air line through the cooling air inlet opening is prevented. It is thus possible to allow for operating states of an engine bleed air system equipped with the cooling air inlet in which cooling air does not need to be supplied to the cooling air line. In particular if the cooling air inlet valve is incrementally or continuously adjustable between its first and its second open position and can additionally also be positioned in a closed position, it is possible to dispense with the arrangement of an additional throttle valve in the cooling air line which, in engine bleed air systems known from the prior art, serves to control the cooling air volume flow through the cooling air line.

The cooling air inlet valve of the cooling air inlet according to the invention may be adjustable between its first open position and its second open position by rotation about an axis, through a linear movement and/or through a rail-guided movement. By rotation about an axis, through a linear movement and/or through a rail-guided movement, the cooling air inlet valve may furthermore be positioned in a closed position in which the cooling air inlet valve closes the inlet portion of the cooling air line. The movement of the cooling air inlet valve between its first open position and its second open position can, like the movement of the cooling air inlet valve into its closed position, be effected by at least one actuator. Only one actuator is preferably provided. However, if required, the cooling air inlet valve can also be equipped with a plurality of actuators.

An engine bleed air system according to the invention, which is particularly suitable for use in an aircraft air conditioning system, comprises a cooling air inlet described above.

In a method according to the invention for operating a cooling air inlet which is particularly suitable for use in an engine bleed air system of an aircraft air conditioning system and comprises a cooling air inlet opening opens into an inlet portion of a cooling line, a first cooling air admission pressure is built up in the inlet portion of the cooling air line in a first operating state of the cooling air inlet as a result of a cooling air inlet valve arranged in the inlet portion of the cooling air line being positioned in a first open position. Furthermore, in the method according to the invention, a second cooling air admission pressure is built up in the inlet portion of the cooling air line in a second operating state of the cooling air inlet as a result of the cooling air inlet valve arranged in the inlet portion of the cooling air line being positioned in a second open position. The second cooling air admission pressure here is greater than the first cooling air admission pressure.

In an intermediate operating state of the cooling air inlet, an intermediate cooling air admission pressure, which is greater than the first cooling air admission pressure and less than the second cooling air admission pressure, can be built up in the inlet portion of the cooling air line as a result of the cooling air inlet valve arranged in the inlet portion of the cooling air line being positioned in the inlet portion of the cooling air line in an intermediate position located between its first and its second open position. The position of the cooling air inlet valve in the inlet portion of the cooling air line can be incrementally or continuously varied between the first open position and the second open position.

In its first open position, the cooling air inlet valve can free a first through-flowable cross-section of the inlet portion of the cooling air line. In contrast, in its second open position, the cooling air inlet valve can free a second through-flowable cross-section of the inlet portion of the cooling air line. The second through-flowable cross-section of the inlet portion of the cooling air line is preferably greater than the first through-flowable cross-section of the inlet portion of the cooling air line.

In its first open position, the cooling air inlet valve is preferably accommodated completely in the inlet portion of the cooling air line.

On the other hand, if the cooling air inlet valve is positioned in its second open position, a portion of the cooling air inlet valve can be arranged outside the inlet portion of the cooling air line and project into an air flow flowing over the cooling air inlet opening The portion of the cooling air inlet valve which is arranged outside the inlet portion of the cooling air line and projects into an air flow flowing over the cooling air inlet opening can be constructed for example in the form of an airscoop.

Finally, the cooling air inlet valve can close the inlet portion of the cooling air line as a result of the cooling air inlet valve in the inlet portion of the cooling air line being positioned in a closed position.

The cooling air inlet valve can be moved between its first open position and its second open position or brought into its closed position by rotation about an axis, through a linear movement and/or through a rail-guided movement. The movement of the cooling air inlet valve between its first open position and its second open position or into its closed position can be effected by at least one actuator.

The cooling air inlet valve may comprise side faces and an end face which is disposed between the side faces. The cooling air inlet valve may be pivotable about an axis disposed within the inlet portion below the cooling air inlet opening such that upon transferring the cooling air inlet valve in the closed position the end face is positioned entirely below the cooling air inlet opening, upon transferring the cooling air inlet valve in the first open position the end face is disposed adjacent to the cooling air inlet opening, and upon transferring the cooling air inlet valve in the second open position the end face protrudes beyond the cooling air inlet opening

The end face may be designed in the form of a convex end face. The inlet portion may comprise a first boundary face and a concave second boundary face which are disposed opposite each other and which extend from the cooling air inlet opening into the inlet portion. The inlet portion may further comprise two side faces which are disposed opposite each other, which are disposed adjacent to longitudinal edges of the first and the second boundary faces and which extend from the cooling air inlet opening into the inlet portion. The concave second boundary face may have a curvature radius (relating to the axis A), which corresponds to a curvature radius of the end face. The cooling air inlet valve may be pivotable about the axis such that the end face moves in a form-closed manner along the concave second boundary face.

### BRIEF DESCRIPTION OF THE DRAWINGS

A preferred embodiment of the invention is now explained in more detail with reference to the accompanying schematic drawings, which show:

FIG. 1 an engine bleed air system known from the prior art,

FIG. 2 a cooling air inlet suitable for use in an engine bleed air system according to FIG. 1, wherein a cooling air inlet valve of the cooling air inlet is in a first open position,

FIG. 3 the cooling air inlet according to FIG. 2, wherein the cooling air inlet valve of the cooling air inlet is in a second open position, and

FIG. 4 the cooling air inlet according to FIG. 2, wherein the cooling air inlet valve of the cooling air inlet is in a closed position.

### DETAILED DESCRIPTION OF THE PREFERRED EMBODIMENTS

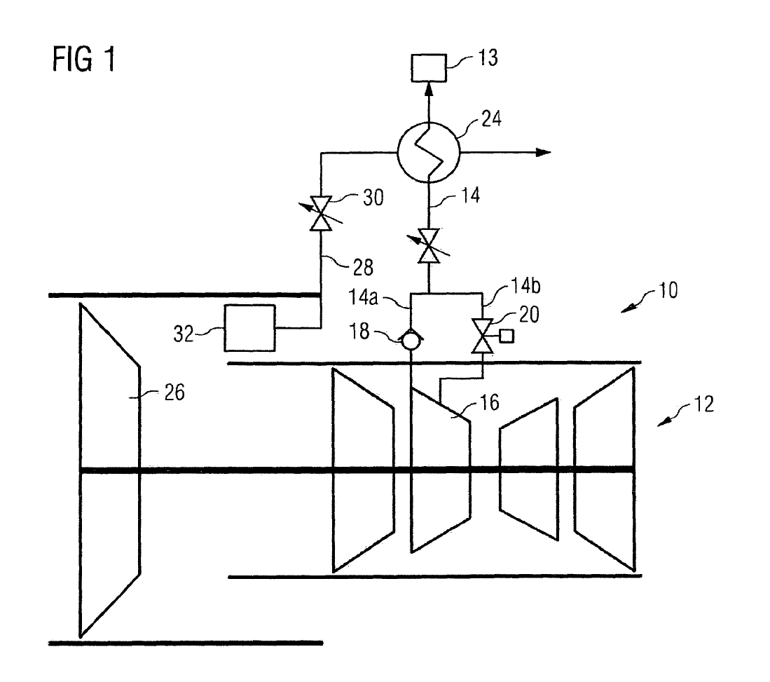

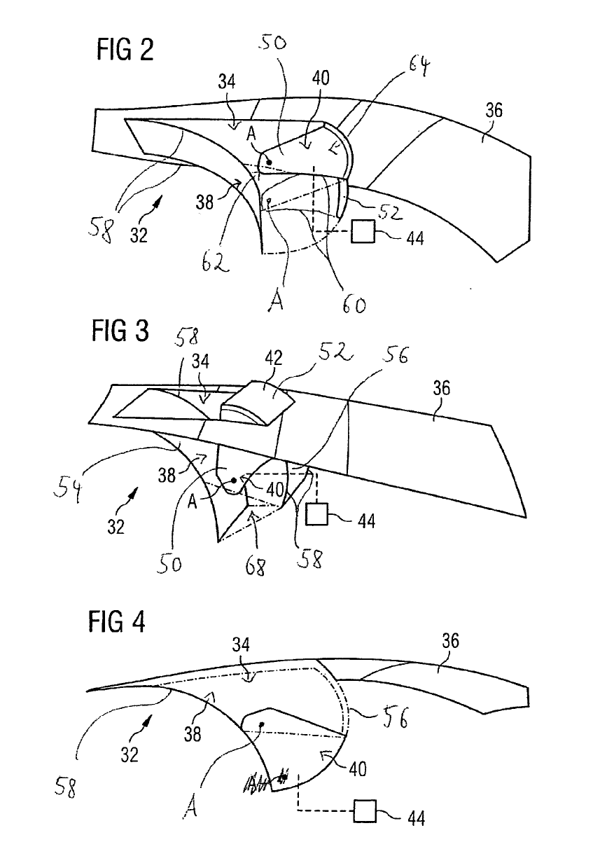

FIGS. 2 to 4 show a cooling air inlet 32 which is suitable for use in an engine bleed air system 10 according to FIG. 1. The cooling air inlet 32 comprises a cooling air inlet opening 34 which is constructed in a surface element 36. When the cooling air inlet 32 is in operation, fan air extracted from the engine 12 of the engine bleed air system 10 (shown in FIG. 1) in the region of the engine fan 26 flows over the surface element 36. The surface element 36 can be formed for example by a flow deflector plate or a portion of a housing arranged in the region of an engine suspension, or the like. The cooling air inlet opening 34 leads into an inlet portion 38 of the cooling air line 28 which, in the engine bleed air system 10 according to FIG. 1, serves to supply cooling air to the preheat exchanger 24.

A cooling air inlet valve 40 is arranged in the inlet portion 38 of the cooling air line 28. In a first open position shown in FIG. 2, the cooling air inlet valve 40 is accommodated completely in the inlet portion 38 of the cooling air line 28 and frees a first through-flowable cross-section of the inlet portion 38 of the cooling air line 28. In its first open position, the cooling air inlet valve 40 therefore enables the supply of cooling air through the cooling air inlet opening 34 into the cooling air line 28. In its first open position, the cooling air inlet valve 40 further effects the build-up of a first cooling air admission pressure pl in the inlet portion 38 of the cooling air line 28.

Conversely, in a second open position shown in FIG. 3, the cooling air inlet valve 40 is positioned in the inlet portion 38 of the cooling air line 28 in such a way that a portion 42 of the cooling air inlet valve 40 is arranged outside the inlet portion 38 of the cooling air line 28. If fan air flows over the cooling air inlet opening 34 during operation of the cooling air inlet 32, that portion 42 of the cooling air inlet valve 40 which is constructed in the form of an airscoop projects into the fan air flow flowing over the cooling air inlet opening 34. In its second open position, the cooling air inlet valve 40 furthermore frees a second through-flowable cross-section of the inlet portion 38 of the cooling air line 28, which is greater than the first through-flowable cross-section of the inlet portion 38 of the cooling air line 28 which is freed by the cooling air inlet valve 40 when it is in its first open position shown in FIG. 2.

In its second open position, the cooling air inlet valve 40 therefore enables the supply of cooling air through the cooling air inlet opening 34 into the cooling air line 28, wherein the cooling air inlet valve 40, by freeing a greater through-flowable cross-section of the inlet portion 38 of the cooling air line 28, enables the supply of a greater cooling air volume flow into the cooling air line 28 in its second open position than in its first open position. Furthermore, as a result of the airscoop portion 42 which is arranged outside the inlet portion 38 of the cooling air line 28 and projects into the air flow flowing over the cooling air inlet opening 34, the cooling air inlet valve 40 in its second open position effects the build-up of a second cooling air admission pressure p2 in the inlet portion 38 of the cooling air line 28 which is greater than the first cooling air admission pressure p1 generated in the inlet portion 38 of the cooling air line 28 by the cooling air inlet valve 40 in its first open position. This enables the cooling air volume flow flowing over the cooling air line 28 to be increased further.

In the exemplary embodiment of a cooling air inlet 32 shown in the figures, the position of the cooling air inlet valve 40 in the inlet portion 38 of the cooling air line 28 is continuously variable between the first and the second open position of the cooling air inlet valve 40. In particular, the cooling air inlet valve 40 can be moved between its first and its second open position by rotation about an axis A. The cooling air inlet valve 40 can therefore be brought into any of the intermediate positions located between the first and the second open position in which the cooling air inlet valve effects the build-up of an intermediate cooling air admission pressure in the inlet portion 38 of the cooling air line 28 which is greater than the first cooling air admission pressure p1 and less than the second cooling air admission pressure p2. The movement of the cooling air inlet valve 40 about the axis of rotation A is effected by an actuator 44.

As shown in FIG. 4, the cooling air inlet valve 40 in the inlet portion 38 of the cooling air line 28 may furthermore be positioned in a closed position in which the cooling air inlet valve 40 closes the inlet portion 38 of the cooling air line 28. Since the cooling air inlet valve 40 enables a continuous variation of the cooling air volume flow flowing through the cooling air line 28 and is moreover capable of also interrupting the cooling air supply to the cooling air line 28 completely, it is possible to dispense with the arrangement of a throttle valve 30, as provided in the engine bleed air system 10 known from the prior art, in the cooling air line 28. The function of the throttle valve 20 is instead assumed completely by the cooling air inlet valve 40.

In operating states of an engine bleed air system 10 equipped with the cooling air inlet 32, in which there is a low cooling air requirement in the engine bleed air system 10, the cooling air inlet valve 40 is positioned in its first open position (shown in FIG. 2) in the inlet portion 38 of the cooling air line 28. In its first open position, the cooling air inlet valve 40 causes a low parasitic resistance in the fan air flow flowing over the cooling inlet opening 32 and thus has only a slight negative effect on the thrust performance and the fuel consumption of the engine 12.

In operating states of the engine bleed air system 10 in which there is a high cooling air requirement in the engine bleed air system 10, the cooling air inlet valve 40 is, on the other hand, positioned in its second open position (shown in FIG. 3) in the inlet portion 38 of the cooling air line 28. In its second open position, the cooling air inlet valve 40 not only frees a greater through-flowable cross-section of the inlet portion 38 of the cooling air line 28, but also effects the generation of a higher cooling air admission pressure in the inlet portion 38 of the cooling air line as a result of its airscoop portion 42 projecting into the fan air flow flowing over the cooling air inlet opening 34. If the cooling air inlet valve 40 is in its second open position, although it causes a greater parasitic resistance in the fan air flow flowing through the cooling air inlet opening 34, and therefore results in a greater reduction in the thrust performance of the engine 12 and a greater increase in the fuel consumption of the engine 12, it nonetheless also ensures that a high cooling air requirement of the engine bleed air system 10 can be accommodated.

Finally, in operating states of the engine bleed air system 10 in which the engine bleed air system 10 does not have a cooling air requirement, the cooling air inlet valve 40 can be brought into its closed position shown in FIG. 4, in which it closes the inlet portion 38 of the cooling air line 28. If the cooling air inlet valve 40 is in its closed position, the parasitic resistance in the fan air flow, which is caused by the cooling air inlet 32, is minimized.

The cooling air inlet valve 40 may comprise side faces (side walls) 50 and an end face 52 which is disposed between the side faces 50. The cooling air inlet valve 40 may be pivotable about an axis A disposed within the inlet portion 38 below the cooling air inlet opening 34 such that upon transferring the cooling air inlet valve 40 into the closed position the end face is positioned entirely below the cooling air inlet opening 34, upon transferring the cooling air inlet valve 40 in the first open position the end face is disposed adjacent to the cooling air inlet opening 34, and upon transferring the cooling air inlet valve 40 in the second open position the end face protrudes beyond the cooling air inlet opening 34.

The end face 52 may be designed in the form of a convex end face. The inlet portion 38 may comprise a first boundary face 54 and a concave second boundary face 56 which are disposed opposite each other and which extend from the cooling air inlet opening 34 into the inlet portion 38. The inlet portion 38 may further comprise two side faces (not shown) which are disposed opposite each other, which are disposed adjacent to longitudinal edges 58 of the first and the second boundary face 54, 56, and which extend from the cooling air inlet opening 34 into the inlet portion 38. The side faces of the inlet portion 38, which are disposed opposite each other, as well as the first boundary face 54 and the second boundary face 56 form at their lower end an opening 68 through which the air entering the inlet portion 38 flows and which in the closed position is closed by the end face 52.

The concave second boundary face 56 may have a curvature radius which corresponds to a curvature radius of the end face 52. The cooling air inlet valve 40 may be pivotable about the axis A such that the end face 52 moves in a form-closed manner along the concave second boundary face 56.

The side faces 50 may comprise concave edges 60, and the first boundary face 54 may have a convex shape, wherein in the closed position the concave edges abut against the first boundary face 54 in a form-closed manner.

The side faces 50 comprise a first end 62 and a second end 64. The axis A, about which the cooling air inlet valve 40 is pivoted, is disposed close to the first end 62. Since the axis A is disposed below the cooling air inlet opening 34, an actuator (or a plurality of actuators) which effects the pivoting of the cooling air inlet valve 40 may be designed larger than in a case wherein the axis A is disposed close to the cooling air inlet opening 34 or in the cooling air inlet opening 34 (in this case the available space for the actuators would be smaller). The width of the side faces 50 at the first end 62 may be smaller than at the second end 64.

When the cooling air inlet valve 40 is closed, the concave curved edges may abut against the convex first boundary face 54 in a form-closed manner, and a portion of the end face 52 may abut against the concave second boundary face 56 in a form-closed manner. Since the air entering the inlet portion 38 exerts a force to the end face 52 substantially in a direction perpendicular to the end face 52, it may be ensured that upon closing the cooling air inlet valve 40 there is only a small risk that the cooling air inlet valve 40, by the inflowing air, is pivoted about the axis A in an unintended manner. Hence, no openings between the end face 52 and the convex first boundary face 54 are formed through which the air could flow passed the end face 52. Further, as long as a part of the end face 52, in the closed position, abuts against the boundary face 56, a pressure which is exerted by the inflowing air to the end face 52 and thus to the axis A is smaller, since pressure is absorbed by the second boundary face 56.

In the second open position a region 66 (the downstream end region) of the cooling air inlet opening 34 which is disposed adjacent to the second boundary face 56 is entirely closed by the end face 52. Hence, in the second open position, it is ensured that air enters the inlet portion 38 only along a flow path which extends below the end face 52, but not above the end face 52. It can thus be ensured that no vibrations of the end face 52 and hence the entire cooling air inlet valve 40 are generated due to the information of two flow paths on different sides of the end face 52. By preventing these vibrations the life time of the cooling air inlet valve 40 (in particular of the axis A and the actuators 44) can be prolonged. Further, in this case the force, which must be provided by the actuator for pivoting the cooling air inlet valve 40 about the axis A is smaller.

Further, as long as the end face 52 in the second open position along the first boundary face 50 somewhat protrudes into the inlet portion 38, it is ensured that also a slight unintended pivoting of the end face 52 about the axis A does not result in the formation of an opening between the end face 52 and the first boundary face 56 due to air having variable pressures which enters the inlet portion 38. Hence, the formation of a second flow path into the inlet portion 38 which extends above the end face 52 is prevented.

By providing the cooling air inlet valve 40 with side walls 50 pressure regains from the air entering the inlet portion 38 are higher than with a valve design with simple two-dimensional flaps without side walls (in particular in the second open position).

Various closed positions, wherein the opening 68 is closed to different extents, are possible between the first open position shown in FIG. 2 and the closed position shown in FIG. 4. Hence, the air flow can be adjusted in a variable manner and may also be zero (completely closed position, see FIG. 4).

In all positions of the valve only a single air flow flows through the inlet portion 38 providing the above described advantages.

If desired, the side walls 50 may be disposed at a distance from the side faces (not shown) of the inlet portion 38 instead of being disposed immediately adjacent to the side faces (not shown) of the inlet portion 38 which are disposed opposite from each other. In this case, even in the maximum closed position (FIG. 4) air may pass by laterally from the cooling air inlet valve 40. This may be advantageous in certain application, wherein the air flow should not be interrupted. This may also be achieved by providing the end face 52 with bores (through-holes).

In the above description the cooling air inlet valve 40 has been described as “hollow” so as to comprise only the elements 50 and 52. Alternatively thereto, the cooling air inlet valve 40 may also be designed in the form of a component with a closed cavity or in the form of a massive component. In this case the cooling air inlet valve 50 may, e.g., comprise a funnel shaped cavity (alternative filled), which is bounded by the side faces 50 and the end face 52. In this embodiment the end face 52 is enlarged such that the side faces 50 along their entire edges are disposed adjacent to the end face 52. A cross section of the funnel shaped design is enlarged from the first end of the side faces 50 to a second end 64 of the side faces 50.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. A cooling air inlet, having a cooling air inlet opening which opens into an inlet portion of a cooling air line, comprising:
a cooling air inlet valve, which is positionable in a first open position or a second open position, being arranged in the inlet portion of the cooling air line,
the cooling air inlet valve being adapted to effect the build-up of a first cooling air admission pressure in the inlet portion of the cooling air line in its first open position and the build-up of a second cooling air admission pressure in the inlet portion of the cooling air line in its second open position,
wherein the second cooling air admission pressure is greater than the first cooling air admission pressure.

2. The cooling air inlet according to claim 1, wherein the cooling air inlet is located in an engine bleed air system of an aircraft air conditioning system.

3. The cooling air inlet according to claim 1,
wherein the position of the cooling air inlet valve in the inlet portion of the cooling air line is one of incrementally and continuously variable between the first and the second open position of the cooling air inlet valve,
wherein the cooling air inlet valve is configured such that, in an intermediate position between its first and its second open position, it effects the build-up of an intermediate cooling air admission pressure in the inlet portion of the cooling air line which is greater than the first cooling air admission pressure and less than the second cooling air admission pressure.

4. A cooling air inlet according to claim 1,
wherein the cooling air inlet valve is configured to free a first through-flowable cross-section of the inlet portion of the cooling air line in its first open position and to free a second through-flowable cross-section of the inlet portion of the cooling air line in its second open position,
wherein the second through-flowable cross-section of the inlet portion of the cooling air line is greater than the first through-flowable cross-section of the inlet portion of the cooling air line.

5. The cooling air inlet according to claim 1,
wherein the cooling air inlet valve is received completely in the inlet portion of the cooling air line in its first open position.

6. The cooling air inlet according to claim 1,
wherein a portion of the cooling air inlet valve is arranged outside the inlet portion of the cooling air line and projects into an air flow flowing over the cooling air inlet opening when the cooling air inlet valve is positioned in its second open position.

7. The cooling air inlet according to claim 6,
wherein the portion of the cooling air inlet valve which is arranged outside the inlet portion of the cooling air line and projects into an air flow flowing over the cooling air inlet portion is constructed in the form of an airscoop.

8. The cooling air inlet according to claim 1,
wherein the cooling air inlet valve in the inlet portion of the cooling air line further is positionable in a closed position in which the cooling air inlet valve closes the inlet portion of the cooling air line.

9. The cooling air inlet according to claim 1,
wherein the cooling air inlet valve is movable between its first open position and its second open position by at least one of a rotation about an axis, a linear movement and a rail-guided movement,
wherein the movement of the cooling air inlet valve between its first open position and its second open position is effected by at least one actuator.

10. The cooling air inlet according to claim 8,
wherein the cooling air inlet valve comprises side faces and an end face which is disposed between the side faces,
wherein the cooling air inlet valve is pivotable about an axis disposed within the inlet portion below the cooling air inlet opening such that upon moving the cooling air inlet valve to the closed position, the end face is disposed entirely below the cooling air inlet opening, upon moving the cooling air inlet valve to the first open position, the end face is disposed adjacent to the cooling air inlet opening, and upon moving the cooling air inlet valve to the second open position, the end face protrudes beyond the cooling air inlet opening.

11. The cooling air inlet according to claim 10, wherein
at least a part of the end face is formed as a convex end face,
the inlet portion comprises a first boundary face and a concave second boundary face, which are disposed opposite each other and which extend from the cooling air inlet opening into the inlet portion, wherein the inlet portion comprises two side faces which are disposed opposite each other, which are disposed adjacent to the longitudinal edges of the first and the second boundary faces, and which extend from the cooling air inlet opening into the inlet portion,
the concave second boundary face has a curvature radius which corresponds to a curvature radius of the convex end face, and
the cooling air inlet valve is pivotable about the axis such that the convex end face moves along the concave second boundary face in a form-closed manner.

12. An engine bleed air system for use in an aircraft air conditioning system, comprising a cooling air inlet according to claim 1.

13. A method for operating a cooling air inlet according to claim 1 in an engine bleed air system of an aircraft air conditioning system and which comprises a cooling air inlet opening which opens into an inlet portion of a cooling air line,
wherein a first cooling air admission pressure is built up in the inlet portion of the cooling air line in a first operating state of the cooling air inlet as a result of a cooling air inlet valve arranged in the inlet portion of the cooling air line being positioned in a first open position, and
wherein a second cooling air admission pressure is built up in the inlet portion of the cooling air line in a second operating state of the cooling air inlet as a result of the cooling air inlet valve arranged in the inlet portion of the cooling air line being positioned in a second open position,
wherein the second cooling air admission pressure is greater than the first cooling air admission pressure.

14. The method according to claim 13,
wherein an intermediate cooling air admission pressure, which is greater than the first cooling air admission pressure and less than the second cooling air admission pressure, is built up in the inlet portion of the cooling air line in an intermediate operating state of the cooling air inlet as a result of the cooling air inlet valve arranged in the inlet portion of the cooling air line being positioned in an intermediate position in the inlet portion of the cooling air line which is located between its first and its second open position,
wherein the position of the cooling air inlet valve in the inlet portion of the cooling air line is one of incrementally and continuously varied between the first and the second open position of the cooling air inlet valve.

15. The method according to claim 13,
wherein the cooling air inlet valve frees a first through-flowable cross-section of the inlet portion of the cooling air line in its first open position and frees a second through-flowable cross-section of the inlet portion of the cooling air line in its second open position,
wherein the second through-flowable cross-section of the inlet portion of the cooling air line is greater than the first through-flowable cross-section of the inlet portion of the cooling air line,
wherein the cooling air inlet valve is accommodated completely in the inlet portion of the cooling air line in its first open position.

16. The method according to claim 13,
wherein a portion of the cooling air inlet valve is arranged outside the inlet portion of the cooling air line and projects into an air flow flowing over the cooling air inlet opening when the cooling air inlet valve is positioned in its second open position,
wherein the portion of the cooling air inlet valve which is arranged outside the inlet portion of the cooling air line and projects into an air flow flowing over the cooling air inlet opening is constructed in the form of an airscoop, and
wherein the cooling air inlet valve closes the inlet portion of the cooling air line as a result of the cooling air inlet valve in the inlet portion of the cooling air line being positioned in a closed position.
